(19) United States
(12) Patent Application Publication
(10) Pub. No.: US 2013/0164457 A1
(43) Pub. Date: Jun. 27, 2013

(54) METHOD OF MANUFACTURING PATTERNED X-RAY OPTICAL ELEMENTS

(71) Applicants: Bodo Ehlers, Northville, MI (US); Licai Jiang, Rochester Hills, MI (US)

(72) Inventors: Bodo Ehlers, Northville, MI (US); Licai Jiang, Rochester Hills, MI (US)

(73) Assignee: RIGAKU INNOVATIVE TECHNOLOGIES, INC., Auburn Hills, MI (US)

(21) Appl. No.: 13/337,654

(22) Filed: Dec. 27, 2011

(51) Int. Cl. C08J 7/18

(52) U.S. Cl. 427/555

(57) ABSTRACT

A pulsed laser beam engraves a groove pattern on substrate of material relatively transparent to the laser beam. The grooves of the pattern are filled with a filling material of different density or different electron density. The pattern of grooves filled with material of different density creates a spatial density modulation that forms the basic structure of various optical elements. By adjusting the flux density of the laser beam to exceed a material break-down threshold only in specific locations, the material ablation can be reduced to a diameter smaller than the diameter of the laser beam itself. The grooves fabricated in this manner can be filled with a deformable material under vacuum with subsequent exposure to air pressure or higher pressure. It is also possible to fill the grooves with nanoparticles of different density and secured by heat application or with a coating.

### TECHNICAL FIELD

The present invention relates to the manufacture of patterned optical elements for use in the optical frequency range of x-rays.

### BACKGROUND

Patterned optical elements for x-ray wavelengths, including Fresnel lenses, zone plates, gratings and resolution charts, differ from typical optical gratings for ultraviolet (UV), visible (VIS), and infrared (IR) wavelength ranges. Processes for producing optical gratings in these longer wavelength ranges cannot be used for and transferred to the production of the patterned optics for the x-ray wavelength range because of differences in the working principles of the processes, in the materials of the optical elements, in the critical dimensions and geometries, and in other aspects. A patterned optic for x-rays changes an x-ray wavefront either by modifying the amplitude or phase or both. The patterned optical element does so through spatial modulation of the electron density of the structure. It is often made of a pattern of varying transmission thickness, or a pattern of different materials, or a combination of both.

One of the simplest patterned optics is a transmission grating. One type of x-ray transmission gratings has a structure of stripes of alternative materials with different electron densities and hence different absorption coefficients and different optical indexes. The intensity and the phase of transmission x-rays are therefore modulated by this structure.

An x-ray transmission grating can be made of one material as well. Instead of alternative materials which contribute to the modulation of the intensity and phase, the grating may have an alternating thickness of the material so that the intensity and the phase are modulated through the transmission.

There are two critical geometrical parameters to describe a transmission grating: the period of the grating and the aspect ratio, which is defined as the ratio between the thickness of the structure and the period. High resolution gratings typically have a period from sub-micrometers to micrometers.

The aspect ratio, i.e. the ratio between the characteristic period and the thickness of the x-ray transmission path is a universal parameter for patterned x-ray optics. A Fresnel lens is a zone plate with concentric rings of different optical paths. The transmitted x-rays constructively interfere with each other at the focal point. The typical dimension of the “ring width” ranges from tens of micrometers to a few tens of nanometers in the x-ray region with energy of a few keV to a few 10 keV. The resolution of a Fresnel lens is determined by the outmost ring, i.e. the ring with the narrowest ring width, by 1.22·ΔRₙ, where ΔRₙ is the width of the outmost ring.

Another example of patterned x-ray optical elements is a resolution chart. A resolution chart is a pattern with variable density. The pattern may include numbers and letters of different sizes, lines of different widths and at different distances, and other different geometric patterns. When positioned in the path of an x-ray beam, the shadow image, or absorption contrast image, shows the imaging resolution of the system. Resolution charts are widely used for characterizing the resolution of x-ray detectors and x-ray imaging systems.

Electron-beam lithography (e-beam lithography) has been used to fabricate these x-ray optics, in which a periodic pattern is engraved by a focused e-beam on a thin film of absorbing material. However, for high-resolution optics, Fresnel lenses and gratings, fabricated for relatively high energy, such as 8 keV and above, the required aspect ratio is too large for e-beam lithography.

### SUMMARY OF THE INVENTION

In overcoming the enumerated drawbacks and other limitations of the related art, the present invention provides an improved method of fabricating pattered x-ray optical elements.

This method addresses issues associated with the fabrication of an optical element for producing intensity and phase modulation to an x-ray wave front. Such optical elements usually have patterned density modulation structure. The method includes utilizing a pulsed laser beam to engrave a pattern on a base plate of material which is generally transparent or less absorbing to x-rays (low-density), and then filling the grooves of the pattern with material which is less transparent to x-rays (high-density). The density modulation using a pattern of grooves filled with high-density material in the less absorbing base plate forms the basic structure of various optical elements. The shape of the pattern depends on the final application. The grooves may be, for example, parallel straight lines or concentric circles or take any other periodical pattern. These optical elements may include x-ray resolution charts for system characterization, zone plates for x-ray microscopy, and x-ray transmission gratings suitable for x-ray interferometry and for phase-enhanced x-ray imaging.

The above described method applies to the phase modulation as well. The difference of the optical indexes of the materials will modify the phase of the wavefront.

In particular, the method involves using a focused femtosecond laser beam to engrave a patterned structure on a substrate of material relatively transparent to the fundamental wavelength of the laser. The fundamental wavelength is the main wavelength of the laser that may also be accompanied by harmonics of shorter wavelengths. Generally, in the following, the term “wavelength” refers to the fundamental wavelength of the laser, unless otherwise noted.

Further, the method according to the invention involves several ways of filling the engraved microscopical structure with a different material. The density contrast between the base material and the filler material forms a density modulated pattern. The contrast of optical index between the base material and the filler material allows phase modulation to an x-ray wavefront.

Further features and advantages will become readily apparent from the following description and from the claims.

### BRIEF DESCRIPTION OF THE DRAWINGS

The accompanying drawings, incorporated in and forming a part of the specification, illustrate several aspects of the present invention and, together with the description, serve to explain the principles of the invention. The components in the figures are not necessarily to scale, emphasis instead being placed upon illustrating the principles of the invention. Moreover, in the figures, like reference numerals designate corresponding parts throughout the views. In the drawings:

FIG. 1 illustrates an ablation of bulk material to machine a grating structure downward from the top of a substrate;

FIG. 2 illustrates a laser ablation through material break-down upward from the bottom of the substrate;

FIG. 3 shows a graph illustrating a material break-down power across a diameter smaller than the laser diffraction limit;

FIG. 4 illustrates laser machining of x-ray grating structures smaller than the diffraction limit; and

FIG. 5 is an illustration of process steps to fill the grating structure with liquid material.

### DETAILED DESCRIPTION OF THE DRAWINGS

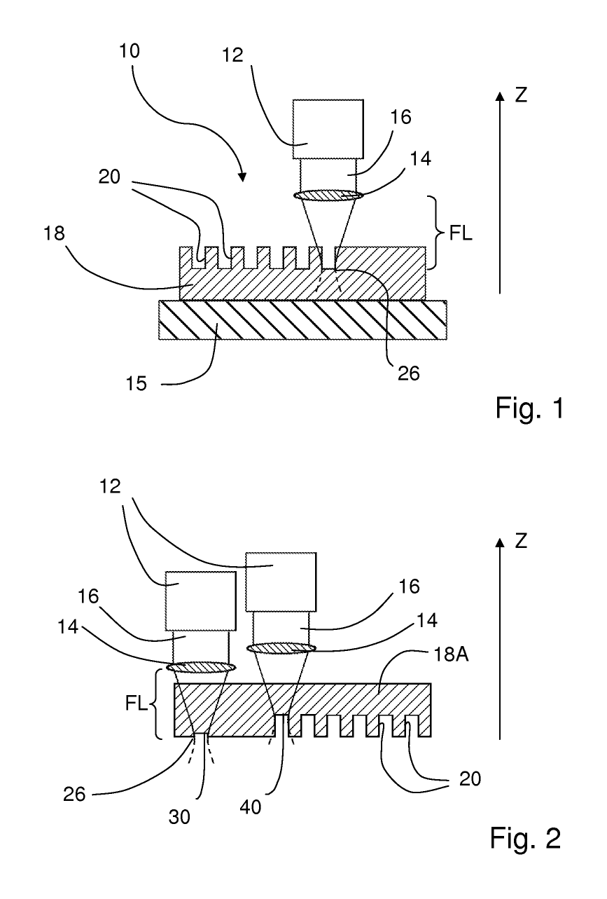

Referring now to FIG. 1, a system for producing x-ray patterned optics embodying the principles of the present invention is illustrated therein and designated at 10. The system 10 includes a source 12 generating a laser beam 16. The laser beam 16 generated by the source 12 passes an optical focusing arrangement 14 with a focal length FL. The laser beam may have a wavelength of a few hundred nanometers up to several micrometers, more specifically between 500 nm and 1.5 μm. At the distance FL from the focusing arrangement 14, the laser beam 16 has a waist 26, at which it reaches its smallest diameter and its highest flux density. The cross-section of the beam waist 26 is called focal spot, where the laser beam 16 has the highest power per area. For the engraving process, the flux density of the laser beam 16 across the focal spot at its waist 26 exceeds a break-down threshold specific to the material of substrate 18. Material removal occurs across the focal spot at the location of the waist 26. Where the laser beam 16 has a wider diameter, the flux density of laser beam 16 remains below the break-down threshold of the material of substrate 18. Accordingly, the energy absorption of the material remote from the beam waist 26 is insufficient to cause ablation, and the material of substrate 18 remains intact. The focal arrangement 14 needs to have a high numerical aperture (N.A.) to achieve this. Additionally, a water-immersed microscope objective can provide a N.A. of 1.2 or even higher. The substrate material can be transparent material such as glass, glass ceramics, crystal quartz, sapphire and other materials. The material may also be non-transparent such as silicon, and other dielectric materials with a low atomic numbers. The position of waist 26 of the laser beam 16 in transversal direction Z in FIG. 1, determines the depth in the substrate 18 at which the material break-down occurs. And the diameter of the laser beam 16 at its waist 26 determines the width of the material break-down.

The laser beam source 12 is turned on with the focusing arrangement 14 having a distance from the substrate 18 that is substantially equal to the focal length FL. Accordingly, the laser beam 16 starts the ablation process at a proximate surface of the substrate 18, also called the first surface. Subsequently, the focusing arrangement 14 is moved closer to the substrate 18 in a controlled manner to ablate material at greater depths until the desired depth of grooves 20 is reached. The material of substrate 18 may be partially transparent to the laser beam wavelength. It must, however absorb the laser beam wavelength to a degree that results in a localized ablation of the substrate material in the area of the beam waist 26.

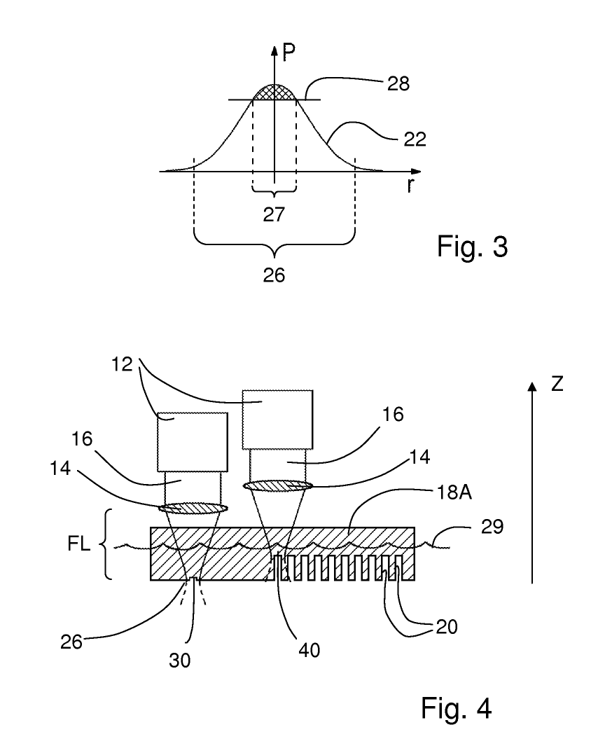

In one form, the laser beam 16 is an ultra-short pulse laser beam that creates the required pattern of grooves 20 in the substrate 18 contained in the patterned optics. A typical laser for this process has a pulse length of 100 femtoseconds and consists of a regenerative amplifier with a laser center wavelength of approximately 800 nm. The beam is transversally monomode and has a beam propagation parameter of M² of ˜1. The pulse energy is typically in the range of several 10 nJ to several 100 nJ or higher in the Micro-Joule range. Due to the short pulse length, there is no significant heat transfer to the residual bulk material of substrate 18 so that a sharp boundary between removed material and still intact material is attainable. Where the laser pulses hit the material of substrate 18, the laser beam energy is absorbed by the bulk material. In locations where the flux density of the laser beam 16 is sufficient to cause a material break-down, the bulk material is ablated and leaves a pattern of grooves 20 with clean and precise edges. The laser beam 16 can engrave structures with high aspect ratios and grooves 20 having a width that may be smaller than the diffraction limit of the wavelength of the laser beam source 12 as described in more detail in connection with FIGS. 3 and 4.

In various implementations, the ultra-short pulsed laser beam 16 can be used in combination with a stage or handling platform 15. The laser beam 16 can be scanned relative to the handling platform 15 to ablate material in the pattern of the grooves 20.

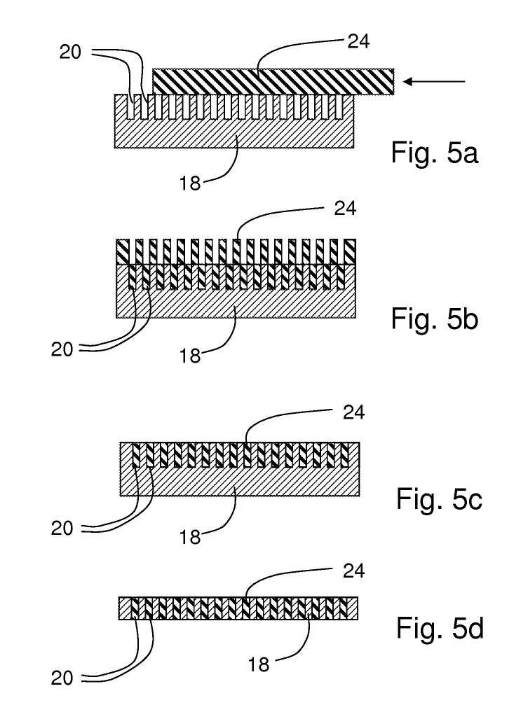

As discussed below in connection with FIG. 5, the voids of the patterned substrate 18 formed by the laser beam 16 are filled with a different element, typically having a high electron density, or a mix of heavy elements to form the patterned structure of substrate 18 which can be used for the modulation of an x-ray wave front.

Under normal operation conditions, the smallest achievable structure width of the patterned optic to be produced is given by the diffraction limit of the laser at the given laser wavelength and single transversal mode operation. Normal operating conditions exist where the flux density of the laser beam 16 anywhere across its defined diameter specifications on the substrate 18 interface exceeds the break-down threshold specific to the material of substrate 18. Material removal occurs across that diameter. Due to the short pulse length, there is no significant heat transfer to the residual bulk material of substrate 18 outside the diameter of laser beam 16 so that there is virtually no heat-affected zone and the boundary between removed material and intact material remains very well defined.

If a substrate 18A is sufficiently transparent to the laser beam wavelength, a configuration as shown in FIG. 2 is possible, in which the material is removed below the surface of substrate 18A. The material of substrate 18A must be partially transparent to the laser beam wavelength so that the laser beam 16 can penetrate the material without causing damage. Non-linear effects, such as multi-photon absorption, may contribute to strong laser beam absorption in the focal plane, where the flux density may be high enough for these effects to occur. The material must absorb the laser beam locally to a degree sufficient to cause ablation. In particular, the beam source 12 may be used in a way that the beam 16 is transmitted through the substrate 18A and brought to a focus in the path of the designed pattern as shown in FIG. 2. Material is ablated along the path. The relative movement between the laser beam 16 and the substrate 18A and the depth of the ablated material forms the patterned structure in substrate 18A.

FIG. 2 shows two grooves 30 and 40 currently being created at different stages of the engraving process. The laser beam 16 generated by the source 12 passes the optical focusing arrangement 14 with the focal length FL. At the distance FL from the focusing arrangement 14, the laser beam 16 has its waist 26, where its flux density is sufficient to exceed the break-down threshold of the material of substrate 18A resulting in ablation of the material at the location of the waist 26. Where the laser beam 16 has a wider diameter, the flux density of laser beam 16 remains below the break-down threshold of the material of substrate 18A, where the energy absorption of the material is insufficient to cause ablation and the material of substrate 18A remains intact. The laser focal spot position, i.e. the waist 26 of the laser beam 16 in transversal direction Z in FIG. 2 determines the depth in the substrate 18A at which the material break-down occurs. To manufacture the grooves 20, the laser beam source 12 is turned on when the laser beam waist 26 is at or near a remote surface (second surface) of substrate 18A to begin the engraving process. The laser beam 16 ablates the bulk material near its waist 26, resulting in groove 30. The minimum of the width of the groove is limited by the diffraction limit for a given laser and focal arrangement. This is typically in the range of 1 micrometer or as small as approximately 0.5 micrometers when using a high numerical aperture immersion objective as the focusing arrangement 14. Subsequently, the focusing arrangement is retracted from the second surface in a controlled manner, causing material at greater depths to be ablated until the groove 30 obtains the depth of groove 40. The depth of the groove is only limited by the working distance of the focal arrangement 14 that is used for the process.

As illustrated in FIG. 4, the width of the grooves 20 can be smaller than a conventionally predicted minimum focus spot of the same dimension as the laser beam waist 26 for a certain wavelength and single transversal mode, or close to the latter. The diagram of FIG. 3 shows the laser flux distribution P over the radius r of the laser beam 16. The material to be ablated has a specific break-down threshold 28 of the laser beam flux density (flux per area) for a given wavelength of the laser beam 16. Above the threshold 28, nonlinear effects occur that enable the deposition of the laser pulse energy into the substrate material, causing material breakdown. While linear absorption is observed at specific wavelengths, non-linear absorption mostly depends on the overall flux density of the laser beam 16 and is largely independent of the wavelength of the laser beam 16. Smaller wavelengths may be better suited to cause non-linear absorption due to the higher photon energy compared to greater wavelengths. Suitable pulse lengths are no longer than 10 ps for non-linear absorption, much shorter than for purely linear absorption. The reason for the short pulse length for non-linear absorption is that the cumulative absorption of a laser pulse might otherwise lead to an undesired excessive material breakdown. The laser pulse parameters are calibrated precisely to achieve a flux density sufficient to exceed the break-down threshold 28 of the substrate material only in an area 27 significantly smaller than the waist 26 of the focused laser beam profile. This area 27 is typically the center area of the laser beam 16 with an overall flux distribution shown by curve 22 having a shape similar or equal to a Gaussian distribution. With this method, structures with lateral features of 100 nm or less can be machined. The depth of the structures is only limited by the working distance of the focal arrangement 14 used.

For achieving a pattern of high feature density and high aspect ratio, the laser scan, or the ablation of the material, has to be three-dimensional. One approach is scan the laser beam 16 in two dimensions to achieve the pattern with the depth of the structure determined by the laser volume above the break-down threshold. Then the laser beam 16 is repositioned perpendicular to the surface of the substrate 18, and the two-dimensional scan is repeated. Multiple iterations may be needed to achieve the desired aspect ratio.

However, one could devise a different beam shape with a characteristic, engineered flux distribution. The respective sub-area 27 of the beam 16 with a flux density exceeding the break-down threshold 28 of the flux density causes the material to be ablated. Preferably, the laser focus position is chosen to create material break-down in the vicinity of a substrate surface to enable a controlled expansion of the removal material which creates a high local pressure. This may be at the first surface of substrate 18 in FIG. 1 or at the second surface of substrate 18A shown in FIG. 2 or in FIG. 4 as explained below.

FIG. 4 shows the two grooves 30 and 40 being created at different stages of the engraving process. The laser beam 16 generated by the source 12 passes the optical focusing arrangement 14 with the focal length FL. At the focal distance FL from the focusing arrangement 14, the laser beam 16 reaches its waist 26, at which it has its smallest diameter and its highest flux density. But only the center of the laser beam waist 26 exhibits a flux density sufficient to exceed the break-down threshold 28. Accordingly, the width of groove 30 corresponds to the width of region 27 of FIG. 3. In analogy to the arrangement of FIG. 2, the position of waist 26 of the laser beam 16 in transversal direction Z determines the depth in the substrate 18A at which the material break-down occurs. The laser beam source 12 starts the engraving process at or near the second surface of substrate 18A. The laser beam 16 ablates the bulk material near its waist 26 across diameter 27, resulting in groove 30. Subsequently, the focusing arrangement is moved away from the second surface, causing material at greater depths to be ablated until the groove obtains the depth of groove 40.

Additional techniques such as super-resolving apertures can be used in the optical setup to reduce the center area of the beam.

Additionally, the bulk structure of substrate 18A may be immersed in liquid 29 to control the process better. A typical liquid is water, water with a surfactant to increase wetting, alcohol, or another solvent with good wetting properties to penetrate into the small ablated features and others. The liquid 29 damps an expansion of the removed material and thus enhances the controllability of the process. The liquid also works in conjunction with an immersion objective used as the focusing arrangement 14.

The finished machined patterned substrate 18 of FIG. 1 or 18A of FIG. 2 or FIG. 4 now represents a base plate of an x-ray patterned optics, such as a grating, made of one material, typically with low electron density.

After the pattered structure in substrate 18 or 18A is formed, the next step involves filling the grooves 20 of the patterned structure with a filling material 24, typically consisting of a heavy element or a mix of heavy elements. The term “heavy element” in this context designates an element with a high electron density, for instance a metal. The choice of one or more elements depends on the desired x-ray absorption, phase change, and the physical properties of the materials. Some examples include metals, preferably, with a high atomic z-number and with low surface tension and a low melting point such as tin and low melting metal alloys such as Field's metal (32.5% Bismuth, 16.5% Tin, and 51.0% Indium) with a very low melting point of 149° F. or an alloy of 5 parts Bismuth, 3 parts Tin with a melting point of 202° F. The physical properties determine the process of filling the grooves 20. Because the characteristic width of the patterned structure of substrate 18 (or 18A) is very small, it is difficult to achieve a wetting of the grating surface by a liquid filling material and to make the filling material penetrate the grooves 20.

FIGS. 5a through 5d illustrate the further process of manufacturing an x-ray grating with spatial density modulation by filling the grooves 20 with a liquid or deformable filling material 24. The process starts according to FIG. 5a with evacuating the volume around substrate 18 and applying the high-density material 24 in a liquid or deformable state on top of the grating structure of substrate 18 while under vacuum. Subsequently, pneumatic pressure is applied in the chamber around the patterned structure of substrate 18 and, in particular, on top of the deformable filling material 24. This pneumatic pressure may be atmospheric air pressure. As illustrated in FIG. 5b, the pneumatic pressure forces the melted metal filling material 24 into the grooves 20. Potential inclusions are minimized due to the initial operation in a vacuum.

For this approach, the elements for filling material 24 with low melting point and low viscosity and low surface tension are preferred. Different elements may be mixed to provide a mixture having low melting temperature or low viscosity or low surface tension, or any combination of these properties to facilitate injecting the mixture into the voids of grooves 20 of the patterned structure in substrate 18.

In the final steps, the residual filling material 24 is removed from the top surface of the substrate 18 or 18A as shown in FIG. 5c, and the excess bulk material of substrate 18 or 18A is removed from the bottom to expose the final patterned structure alternating between the material of substrate 18 or 18A and the filling material 24, as shown in FIG. 5d. After removing the excess bulk material, the alternating materials provide for an enhanced contrast because only one material is present across the thickness of the structure at any given location. The final thickness of the structure is individually chosen to optimize its optical properties for a given application. The finished structure as shown in FIG. 5d may be an optical element, such as a Fresnel lens, a zone plate, a resolution chart, or a grating.

Other methods are conceivable to fill in the voids 20 of the patterned structure. One example is filling in the voids with nanoparticles of high electron density material, and then fixed the structure by melting the filler material 24 or by a top coat. It is, for example possible to fill the voids of the patterned structure of substrate 18 with high-density nanomaterials. Some heavy materials in the form of nanoparticles have been developed with a typical dimension of less than 100 nm. These materials might be suitable for filling in the voids of the patterned structure. Heat melting the filler material or a coating securing the nanoparticles in the grooves 20 can be applied to make the filled structure permanent.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for fabricating an x-ray optical element comprising the steps of:
providing a substrate made of a substrate material with a defined flux density threshold to cause material break-down;
providing a laser configured to produce a pulsed laser beam locally exceeding the flux density threshold;
engraving a pattern of grooves in the substrate by exposing the substrate to the pulsed laser beam at locations defined by the pattern of grooves; and
filling the grooves with a filling material different from the material of the substrate, thus forming a pattern of contrast in at least one of optical density and optical index.

2. The method of claim 1, wherein the flux density threshold is defined for linear absorption at a specific wavelength and the laser produces the pulsed laser beam with the specific wavelength.

3. The method of claim 2, wherein the laser beam has a pulse length of at most 1 μs.

4. The method of claim 1, wherein the flux density threshold is defined for non-linear absorption.

5. The method of claim 4, wherein the laser beam has a pulse length of at most 1 ps.

6. The method of claim 1, wherein the laser beam has a fundamental wavelength within a range of 500 nm to 1.5 μm.

7. The method of claim 1, wherein the laser beam consists of pulses with an individual pulse energy within a range of 10 nJ to 1 μJ.

8. The method of claim 1, wherein the pulsed laser beam has a diameter and a flux distribution that reaches the flux density threshold in a subarea having a smaller diameter than the laser beam.

9. The method of claim 1, further including the step of passing the laser beam through an optical focusing arrangement with a focal length.

10. The method of claim 9, comprising the step of placing the focusing arrangement at a distance from the substrate that is substantially equal to the focal length; and subsequently moving the focusing arrangement toward the substrate by a distance calculated to produce an intended groove depth.

11. The method of claim 9, wherein the substrate is a plate with a first surface proximate to the laser source and with an opposite second surface remote from the laser source, the method comprising the steps of:
placing the focusing arrangement at a distance from the second surface of the substrate that is substantially equal to the focal length; and
subsequently moving the focusing arrangement away from the second surface by a distance calculated to produce an intended groove depth.

12. The method of claim 11, comprising the step of partially immersing the plate in liquid while the laser beam engraves the grooves.

13. The method of claim 12, wherein the liquid comprises water.

14. The method of claim 13, wherein the liquid is water with an added surfactant.

15. The method of claim 12, wherein the liquid comprises alcohol.

16. The method of claim 11, wherein the plate consists of a material that is partially transparent at a wavelength of light emitted by the laser beam.

17. The method of claim 1, wherein the grooves are filled comprising the steps of:
applying the filling material to the groove pattern in a liquid or deformable state under vacuum in a chamber,
increasing a pneumatic pressure in the chamber to a value that causes the filling material to penetrate the grooves,
removing excessive amounts of the filling material to expose a periodical pattern of alternating materials of high and low electron density.

18. The method of claim 17 further comprising the step of thinning the substrate to a thickness that produces a suitable contrast between the materials of high and low electron density.

19. The method of claim 1, wherein the filling material comprises tin.

20. The method of claim 19, wherein the filling material further comprises Bismuth.

21. The method of claim 19, wherein the filling material further comprises Indium.

22. The method of claim 1, wherein the grooves are filled comprising the steps of:
injecting nanoparticles of the material with higher electron density into the grooves,
heating the groove pattern to a temperature at which the nanoparticles melt, and
cooling the groove pattern to a temperature at which the nanoparticles solidify.

23. The method of claim 1, wherein the grooves are filled comprising the steps of:
injecting nanoparticles into the grooves,
applying a coating over the filled grooves that secures the nanoparticles in the grooves.

24. The method of claim 1, wherein the pattern comprises parallel lines.

25. The method of claim 1, wherein the pattern comprises concentric circles.

26. The method of claim 1, wherein the substrate consists of a material with a lower electron density than the filling material.

27. The method of claim 1, wherein the said substrate consists of a material with a higher electron density than the filling material.
